(19) United States
(12) Patent Application Publication
(10) Pub. No.: US 2005/0237411 A1
(43) Pub. Date: Oct. 27, 2005

(54) Camera and control method for camera

(76) Inventor: Sayuri Watanabe, Hachioji-shi (JP)

Correspondence Address: STRAUB & POKOTYLO, 620 TINTON AVENUE, BLDG. B, 2ND FLOOR, TINTON FALLS, NJ, 07724, US

(21) Appl. No.: 11/108,536

(22) Filed: Apr. 18, 2005

(30) Foreign Application Priority Data
Apr. 23, 2004 (JP) 2004-128546

(51) Int. Cl. H04N 5/222

(52) U.S. Cl. 348/333.02; 348/333.01; 348/333.12

(57) ABSTRACT

A camera according an aspect of the invention includes a display unit, a control unit, and a selection unit which selects one of a plurality of scenes prepared in the first explanatory image and the second explanatory image. The control unit displays, as a first explanatory image, a plurality of icons diagrammatically illustrating contents of the scenes as operation guides for the selection unit, and a first sample image serving as a main image representing the contents of the scene corresponding to one of the icons selected by the selection unit, and, as a second explanatory image, a plurality of icons and a descriptive image serving as a main image describing the contents of the scene corresponding to one of the icons selected by the selection unit.

### CROSS-REFERENCE TO RELATED APPLICATIONS

This application is based upon and claims the benefit of priority from prior Japanese Patent Application No. 2004-128546, filed Apr. 23, 2004, the entire contents of which are incorporated herein by reference.

### BACKGROUND OF THE INVENTION

1. Field of the Invention

The present invention relates to a camera which supports the operation of selecting an optimal photographing condition from a plurality of photo-graphing conditions for each of photographic occasion by efficient procedures.

2. Description of the Related Art

Photographing conditions including aperture, shutter speed, ISO sensitivity, and the like can be variously set within a predetermined range. Many recent cameras have two operation modes, i.e., manual mode for manually setting these items, and auto mode for automatically setting all the items in accordance with the situation at a given time.

In order to obtain an image as intended, photography should be performed in manual mode. In this case, however, the user needs to have a degree of knowledge and skill. In contrast to this, in the auto mode, the user need not have such knowledge or skill, and can perform photography at least without failing to an image. When photography is performed in the auto mode, however, a character image is often obtained.

Under the circumstances, an increasing number of cameras have a so-called scene mode which is an improvement on the auto mode in terms of user's convenience. The scene mode allows a user to easily set optimal photographing conditions in accordance with specific scenes, e.g., portrait photography and sports photography. In addition, as a method of efficiently selecting a desired scene from a plurality of scenes prepared in this scene mode, for example, a method of presenting combinations of sample images of the respective scenes and explanatory descriptions has been proposed (see Jpn. Pat. Appln. KOKAI Publication No. 2002-247418).

Recently, portable electronic devices which run on batteries have been strongly required to achieve a reduction in size and weight as well as an improvement in functionality. Many camera have followed the tendency toward a reduction in size and weight. That is, a camera following this tendency can be equipped with only a compact image display device. Even if, therefore, combinations of sample images and explanatory descriptions are presented on such a compact image display device, an unskilled user may not sufficiently comprehend the characteristic features of the respective scenes. On the other hand, in order to allow a skilled user to select a desired scene, it is sufficient to present the minimum necessary information. However, too much unnecessary information makes it difficulty for the skilled user to understand the information.

### BRIEF SUMMARY OF THE INVENTION

According to an aspect of the present invention, it is an object to provide a camera and a control method for the camera which support the operation of selecting an optimal photographing condition from a plurality of photographing conditions on each photographic occasion by efficient procedures.

In order to achieve the above object, according to an aspect of the present invention, there is provided a camera comprising a display unit, a control unit which displays, on the display unit, a first explanatory image and a second explanatory image for selection of a scene for photographing condition setting, and a selection unit which selects one of a plurality of scenes prepared in the first explanatory image and the second explanatory image, wherein the control unit displays, as the first explanatory image, a plurality of icon images diagrammatically illustrating contents of the scenes as operation guides for the selection unit and a first sample image as a main image which represents the contents of the scene corresponding to one of the icon images which is selected by the selection unit, and as the second explanatory image, a plurality of icon images and descriptive image as a main image which describes the contents of the scene corresponding to one of the icon images which is selected by the selection unit.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing a camera according to a first embodiment of the present invention when viewed from the front;

FIG. 2 is a perspective view showing the camera according to the first embodiment when viewed from the rear;

FIG. 3 is a block diagram showing the internal arrangement of the camera body according to the first embodiment;

FIG. 4 is a view of window transition showing the flow of scene descriptions in the scene function executed by the camera according to the first embodiment;

FIG. 5 is an enlarged view showing a first-step explanatory window displayed on the camera according to the first embodiment to make it easier to understand;

FIG. 6 is an enlarged view showing a second-step explanatory window displayed on the camera according to the first embodiment to make it easier to understand;

FIG. 7 is a view showing part of a setting example of photographing conditions in the respective photographing modes in the camera according to the first embodiment;

FIG. 8 is a flowchart showing a control sequence executed by a system controller in the camera according to the first embodiment;

FIG. 9 is a flowchart showing the flow of photographing mode selection processing executed by the system controller in the camera according to the first embodiment;

FIG. 10 is a view of window transition showing the flow of scene description in the scene function executed by the camera according to the first embodiment (modification);

FIG. 11 is a flowchart showing a control sequence executed by the system controller in the camera according to the first embodiment (modification);

FIG. 12 is a view of window transition showing the flow of scene descriptions in a scene function executed by a camera according to the second embodiment of the present invention;

FIG. 13 is an enlarged view showing a first-step explanatory window displayed on the camera according to the second embodiment to make it easier to understand; and

FIG. 14 is an enlarged view showing a second-step explanatory window displayed on the camera according to the second embodiment to make it easier to understand.

### DETAILED DESCRIPTION OF THE INVENTION

The embodiments of the present invention will be described below with reference to the views of the accompanying drawing.

### First Embodiment

A first embodiment of the present invention will be described first.

In the following description, the first explanatory image described above comprises an explanatory window b1, a storage unit comprises an EEPROM 32, the second explanatory image comprises an explanatory window c1, an icon image comprises icon images b21 to b25, the first sample image comprises a sample image b11, and the second sample image comprises a sample image c11.

FIG. 1 is a perspective view showing a camera according to the first embodiment when viewed from the front. This camera is a digital camera which forms an object image on an image sensor through a lens, converts it into an electrical signal, and records the resultant image data of the object image on a recording medium. As shown in FIG. 1, the front surface of the housing of the camera is provided with an aperture portion 1 for allowing object light to enter the camera body and an electronic flash 2 for irradiating an object with light. The upper surface of the housing is provided with a release button 3 for instructing photographing operation at a desired timing.

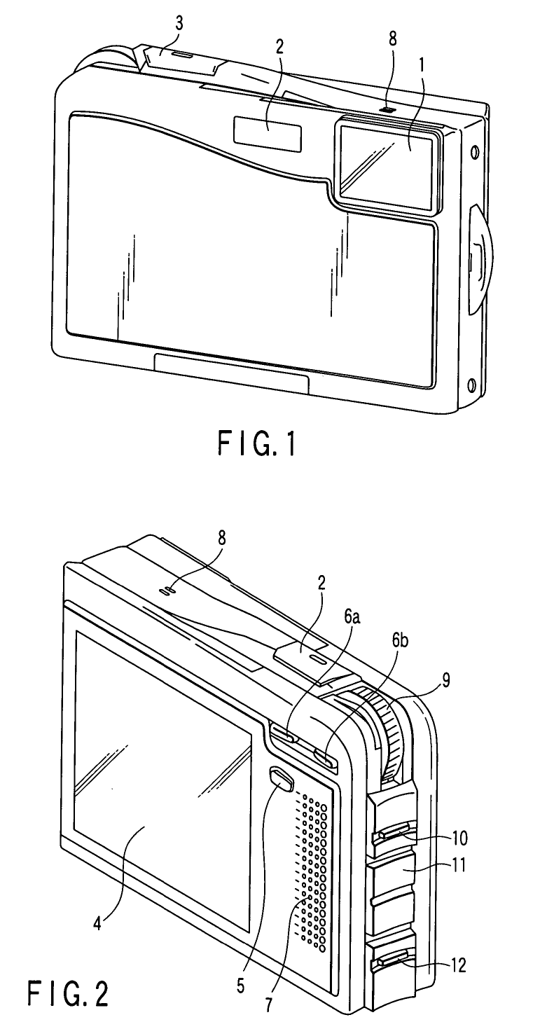

FIG. 2 is a perspective view showing the camera according to the first embodiment when viewed from the rear. As shown in FIG. 2, the rear surface of the housing of this camera is provided with a color liquid crystal display (LCD) 4 for displaying an object image and various kinds of menus, a menu/OK button 5 for making the LCD 4 display a menu or performing operation in response to the displayed menu, zoom buttons 6a and 6b for performing zoom operation, and a loudspeaker 7 for voice output. The upper surface of the housing is provided with a microphone 8 for voice input. One side of the housing is provided with a dial 9 for performing scene selection (to be described later), a back button 10 for returning to immediately preceding menu operation, a switch 11 for switching the camera operation between the photographing mode and the playback mode, and a power supply button 12 for turning on/off the power supply of the camera.

This camera has a scene selecting function. With this function, when one of typical scenes (to be sometimes referred to as scenes hereinafter) prepared as choices, including “landscape”, “landscape and human figure”, “nightscape”, “nightscape and human figure”, and the like, is selected, a photographing condition suitable for photography in the selected scene is automatically set. The dial 9 is used to select a scene in this scene selecting function. When a scene is selected with the dial 9, the description of the scene is displayed on the LCD 4. In this camera, the description of the scene is executed by a very efficient procedure. This point will be described in detail below.

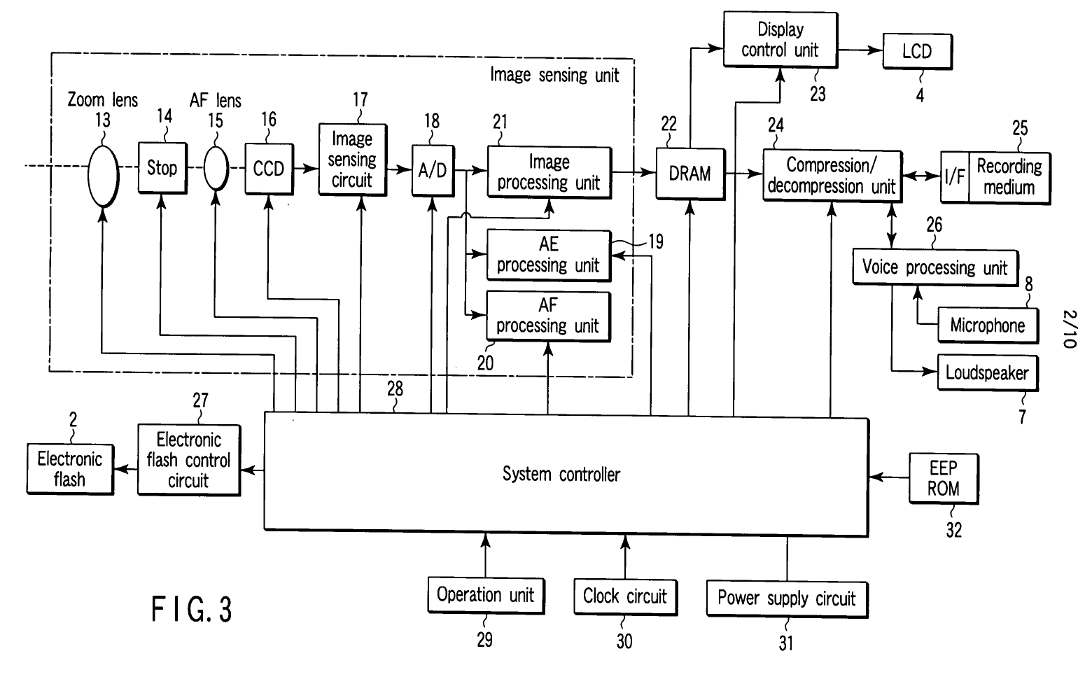

The internal arrangement of this camera will be described first with reference to FIG. 3. Object light passing through a zoom lens 13 provided in the aperture portion 1 further passes through a focus (automatic focus adjustment) lens 15 after the light amount is controlled by a stop 14. The object light passing through the zoom lens 13, stop 14, and focus lens 15 strikes a CCD (two-dimensional color image sensor) 16 to form an object image on its image sensing surface.

The CCD 16 has an image sensing surface on which a plurality of pixels for photoelectric conversion are arranged in the form of a two-dimensional matrix. In addition, color filters are arranged on the image sensing surface. The CCD 16 stores signal charges corresponding to the object image formed on the image sensing surface. An image sensing circuit 17 is connected to the CCD 16. The image sensing circuit 17 controls exposure, read operation, element shutter, gain adjustment, power supply, and the like. The image signal output from the CCD 16 is converted into a digital signal by an A/D converter 18. The resultant signal is input to an AE (Automatic Exposure) processing unit 19, focus processing unit 20, and image processing unit 21.

The AE processing unit 19 receives the digital image signal output from the A/D converter 18, and performs arithmetic computation mainly based on cumulatively addition of image signals from the respective pixels, thereby obtaining an AE evaluation value corresponding to the brightness of the object on the basis of the cumulative addition value.

Upon receiving the digital image signal output from the A/D converter 18, the focus processing unit 20 extracts, for example, high-frequency components of the pixel signal which correspond to the central portion of the image through a high-pass filter, and performs arithmetic processing such as cumulative addition for the extracted components, thereby calculating a focus evaluation value corresponding to the amount of contour components on the high-frequency side.

The image processing unit 21 generates a color image signal in a predetermined format by performing ISO sensitivity setting, automatic white balancing, luminance/chrominance signal generation, gamma processing, and the like for the digital pixel signal output from the A/D converter 18.

The color image signal generated by the image processing unit 21 is temporarily stored in a DRAM 22 serving as a buffer memory. A display control unit 23 is connected to the DRAM 22, and converts the color image signal into a form suitable for a display output. The resultant signal is then supplied to the LCD 4 to be displayed as a monitor image in real time.

A compression/decompression unit 24 is further connected to the DRAM 22. The compression/decompression unit 24 comprises a compression processing unit which reads out an image signal stored in the DRAM 22 and compresses (codes) the signal to convert the signal into a form suitable to be recorded on a recording medium 25, and a decompression processing unit which reads out an image signal recorded on the recording medium 25 and decompresses (decodes) it. In the playback mode, a decompressed image signal is temporarily stored in the DRAM 22 and is displayed on the LCD 4 through the display control unit 23 as needed. The compression/decompression unit 24 can also perform compression processing and decompression processing for a voice signal. A voice input from the microphone 8 is digitized by a voice processing unit 26 and compressed by the compression/ decompression unit 24. The resultant signal is recorded on the recording medium 25. In the playback mode, the signal is read out from the recording medium 25 and decompressed by the compression/decompression unit 24, and is converted into an analog signal by the voice processing unit 26. This signal is then output from the loudspeaker 7.

An electronic flash control circuit 27 is a circuit which controls the amount of light emitted from the electronic flash 2, and includes an electronic flash capacitor capable of storing a predetermined of charge. The electronic flash control circuit 27 drives the electronic flash 2 by charging and discharging this electronic flash capacitor.

The operation of each component described above is controlled by a system controller 28. The system controller 28 controls each component on the basis of the processing results obtained by the AE processing unit 19 and focus processing unit 20 and commands from an operation unit 29 (corresponding to the release button 3 in FIG. 1, the dial 9 and back button 10 in FIG. 2, and the like), and is formed by using a CPU.

A clock circuit 30 is a timepiece module which incorporates its own battery and continuously counts time even when the power supply of the camera body is turned off. The clock circuit 30 outputs the counted time information. A power supply circuit 31 controls the supply of power necessary for the operation of each component.

An EEPROM 32 is an electrically erasable and programmable nonvolatile memory, in which various kinds of processing programs and various kinds of information used for these processing programs are stored. The data which includes information used for describing scenes, sample images, explanatory descriptions, icons which are described later, and the like, are all stored in the EEPROM 32.

An sample image may be stored after being compressed. In this case, when the image is to be displayed, it is decompressed by the compression/decompression unit 24.

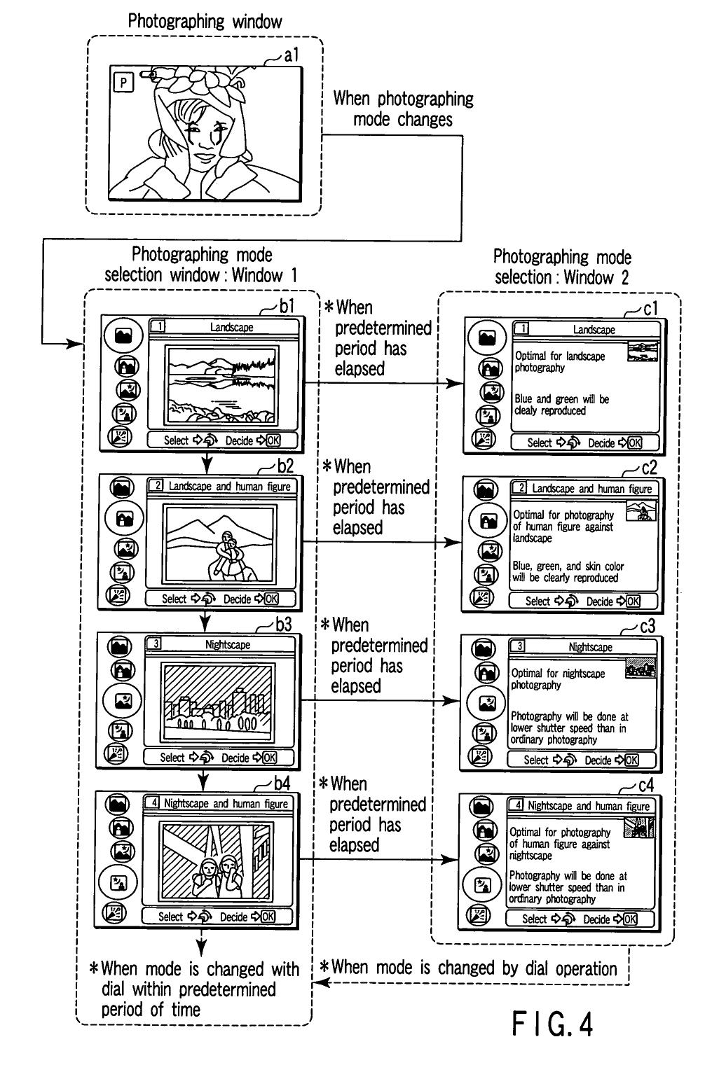

The flow of scene descriptions in the scene selecting function executed by this camera will be described next with reference to FIG. 4. The situation that the scene selecting function is performed is defined as “scene selection”.

FIG. 4 is a view showing the transition of windows displayed on the LCD 4 of the camera. In the photographing mode, a photographing window al as a monitor image (the left side in FIG. 4) is normally displayed on the LCD 4. In this camera, a photographing condition for the auto mode is initially set, but which can be switched to a photographing condition for an arbitrary scene in the scene mode by operating the dial 9 or the like. “P” at the upper left position in the photographing window al indicates that the photographing condition for the auto mode is set. Note that in this case, each time the dial 9 is operated, a scene is selected in order of “landscape”, “landscape and human figure”, “nightscape”, and “nightscape and human figure”.

In this state, when the dial 9 is operated, the first-step explanatory window b1 (the first image in the middle of FIG. 4) of the first scene, i.e., “landscape”, is displayed on the LCD 4. FIG. 5 is an enlarged view showing the explanatory window b1 to make it easier to understand. As shown in FIG. 5, the explanatory window b1 comprises the typical sample image b11 of this scene as a display element. Since the sample image b11 is the display element, the explanatory window b1 can sufficiently inform the characteristic feature of the scene even on the compact LCD 4 having an only limited display area.

In addition to an icon b21 which diagrammatically illustrates the selected scene (“landscape”), icons b22, b23, . . . which diagrammatically illustrate the remaining scenes are simultaneously displayed on the left side of the explanatory window b1 as guides for dial operation.

This icon display allows a skilled user to know at a glance that the selected scene is “landscape” and switched to “landscape and human figure” by one turn of the dial 9 and to “nightscape” by two turns of the dial 9. Every time the dial 9 is operated, the first-step explanatory windows of the respective scenes shown in the middle column in FIG. 4 are cyclically switched from top to bottom. When the menu/OK button 5 is pressed while a desired scene is displayed on the LCD 4, a photographing condition corresponding to the scene is set, and the display of the LCD 4 returns to the photographing window a1. While an explanatory window is displayed on the LCD 4, release operation can be performed. When the release button 3 is pressed, photography is immediately performed under the photographing condition corresponding to the scene. Thereafter, the display of the LCD 4 returns to the photographing window a1.

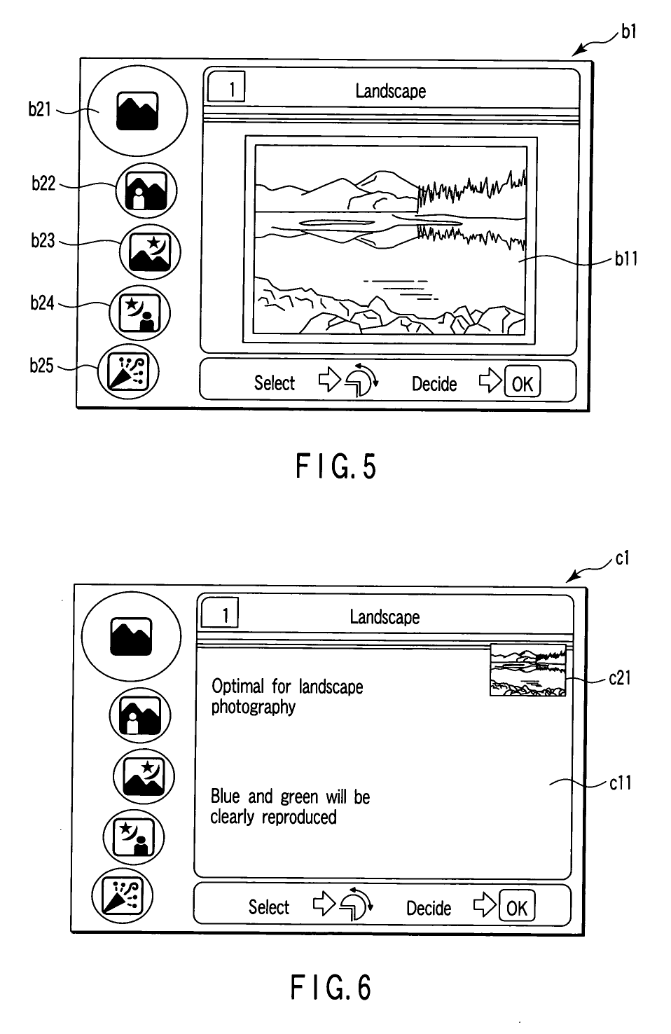

When a predetermined period(e.g., three seconds) has elapsed without any operation since the explanatory window b1 was displayed on the LCD 4, the second-step explanatory window c1 (the first image on the right side in FIG. 4) of the scene is displayed on the LCD 4. FIG. 6 is an enlarged view showing the explanatory window c1 to make it easier to understand. As shown in FIG. 6, the explanatory window c1 comprises the sample image c11 of the scene as a display element. As alternated the sample image b11 described above, the explanatory window c1 comprises the sample image c11 as a display element. Even on the compact LCD 4 having only a limited display area, the explanatory window c1 can present a description with more detailed contents to an unskilled user.

Like the explanatory window b1, icons are displayed as guides for dial operation on the left side of the explanatory window c1. In addition, a reduced image c21 of the sample image b11 is displayed on the upper right side. This visually helps the user to understand the description.

The flow of scene descriptions in a case wherein when the menu/OK button 5 or release button 3 is pressed while the explanatory window c1 is displayed on the LCD 4 is the same as the case of the first-step explanatory window b1. When, however, the dial 9 is operated, the second-step explanatory windows are not switched, but the first-step explanatory windows are cyclically switched while the first-step explanatory window display mode is restored. When a predetermined period has elapsed in this state, the photographing condition corresponding to the scene is set, and the display of the LCD 4 returns to the photographing window al.

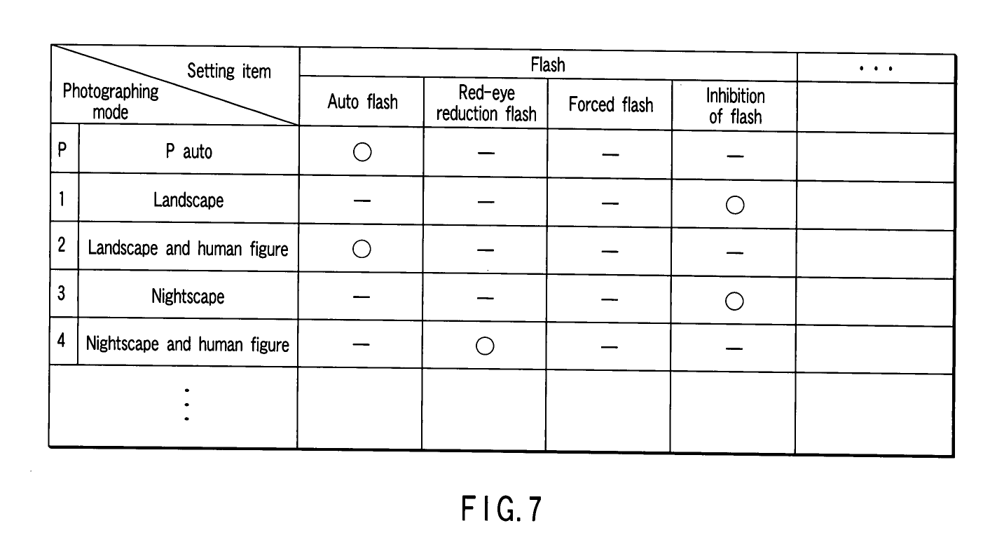

FIG. 7 shows part of a setting example of a photographing condition in each scene selected by such a procedure. As shown in FIG. 7, for example, the electronic flash 2 is set to inhibition of flash in “landscape” and to auto flash in “landscape and human figure” by the system controller 28 in accordance with selected scene.

That is, this camera is designed to perform the multistep guide display operation comprising the first-step guide display operation of displaying a sample image as an element and the second-step guide display operation of displaying a description of each scene as an element, thereby realizing scene descriptions by very efficient procedures in consideration of the knowledge and degree of skill of each user and the limited display area.

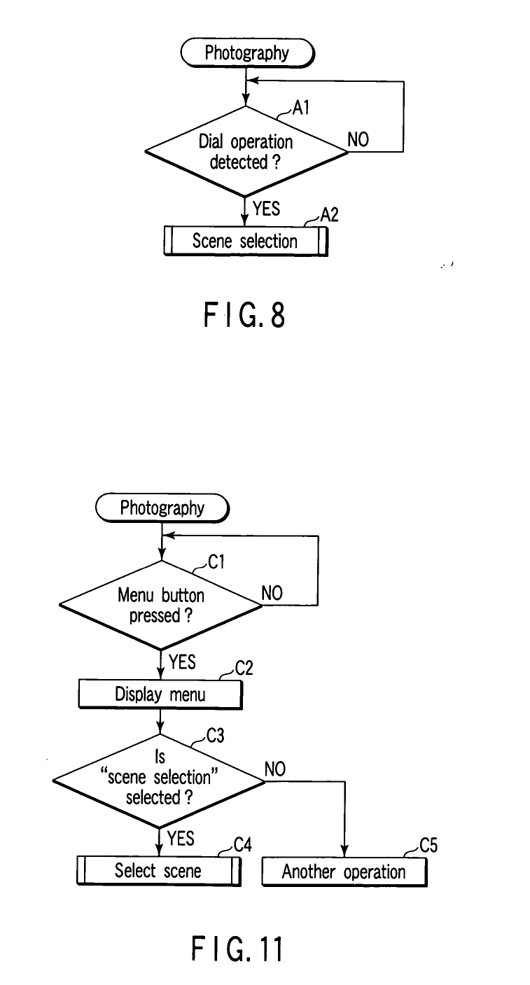

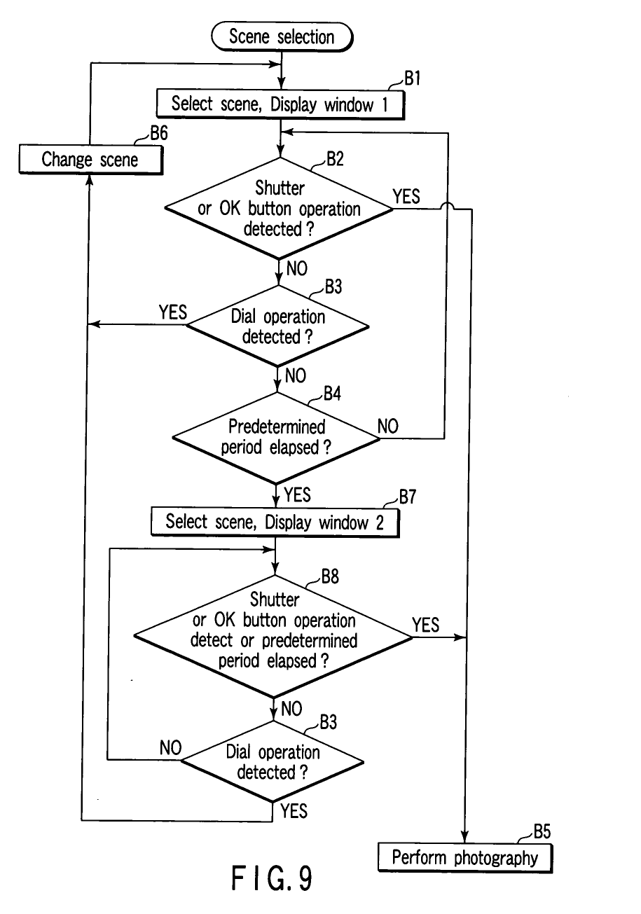

A control sequence executed by the system controller 28 to realize the above window transition will be described with reference to FIGS. 8 and 9.

Upon being notified by the operation unit 29 of the operation of the dial 9 (YES in step A1 in FIG. 8), the system controller 28 executes scene selection processing (step A2 in FIG. 8). FIG. 9 is a flowchart showing the flow of this scene selection processing.

In response to the operation of the dial 9, first of all, the system controller 28 reads out information for forming a first-step explanatory window (window 1) of the next scene, i.e., a sample image, icons, and the like from the EEPROM 32, and instructs the display control unit 23 to display the first-step explanatory window formed by these pieces of information on the LCD 4 (step B1). The system controller 28 then checks whether or not the operation of the release button 3, menu/OK button 6, or dial 9 has been notified (steps B2 and B3). If neither operation have been notified (NO in step B2 and NO in step B3), the system controller 28 checks whether or not a predetermined period has elapsed (since the presentation of the first-step explanatory window) (step B4).

If the operation of the release button 3 or menu/OK button 5 is notified from the operation unit 29 before the lapse of the predetermined period (YES in step B2), the system controller 28 returns to photographing processing for photography using the photographing condition corresponding to the scene (step B5). If the operation of the dial 9 is notified from the operation unit 29 (YES in step B3), the system controller 28 reads out pieces of information for forming the first-step explanatory window of the next scene from the EEPROM 32, and instructs the display control unit 23 to display the first-step explanatory window formed by these pieces of information on the LCD 4 (step B6). Thereafter, the system controller 28 repeats the processing from step B1.

When the predetermined period of time has elapsed without notification of the operation of the release button 3 or dial 9 (step B2), the system controller 28 reads out pieces of information for forming a second-step explanatory window (window 2) of the scene, i.e., a description, a reduced sample image, and the like, from the EEPROM 32, and instructs the display control unit 23 to display the explanatory window formed by these pieces of information on the LCD 4 (step B7). The image information of a sample image on each second-step explanatory window is separately prepared in the EEPROM 32 in order to improve the response characteristic. It may suffice to create a second-step sample image by reducing a first-step sample image by using the image processing unit 21, as needed, instead of preparing a second-step sample image in the EEPROM 32.

If the system controller 28 is notified by the operation unit 29 of the operation of the release button 3 or menu/OK button 5 or a predetermined period has elapsed (YES in step B8) since this second-step explanatory window was presented, the flow returns to the photographing processing for photography using the photographing condition corresponding to the scene (step B5). If notified by the operation unit 29 of the operation of the dial 9 (YES in step B9), the system controller 28 reads out pieces of information for forming a first-step explanatory window of the next scene (not a second-step explanatory window) from the EEPROM 32, and instructs the display control unit 23 to display the first-step explanatory window formed by these pieces of information on the LCD 4 (step B6). Thereafter, the system controller 28 repeats the processing from step B1.

Note that in step B8, it is determined whether the release button 3 is pressed and whether the menu/OK button 5 is operated and a predetermined period has elapsed. With regard to the operation of the menu/OK button 5 and the lapse of the predetermined period, however, this step may be modified such that only one of them is included in the condition.

With the above control sequence provided for the system controller 28, this camera performs the multistep guide display operation comprising the first-step guide display operation of displaying a sample image as an element and the second-step guide display operation of displaying a description of each scene as an element. This makes it possible to realize scene descriptions by very efficient procedures in consideration of the knowledge and degree of skill of each user and the limited display area.

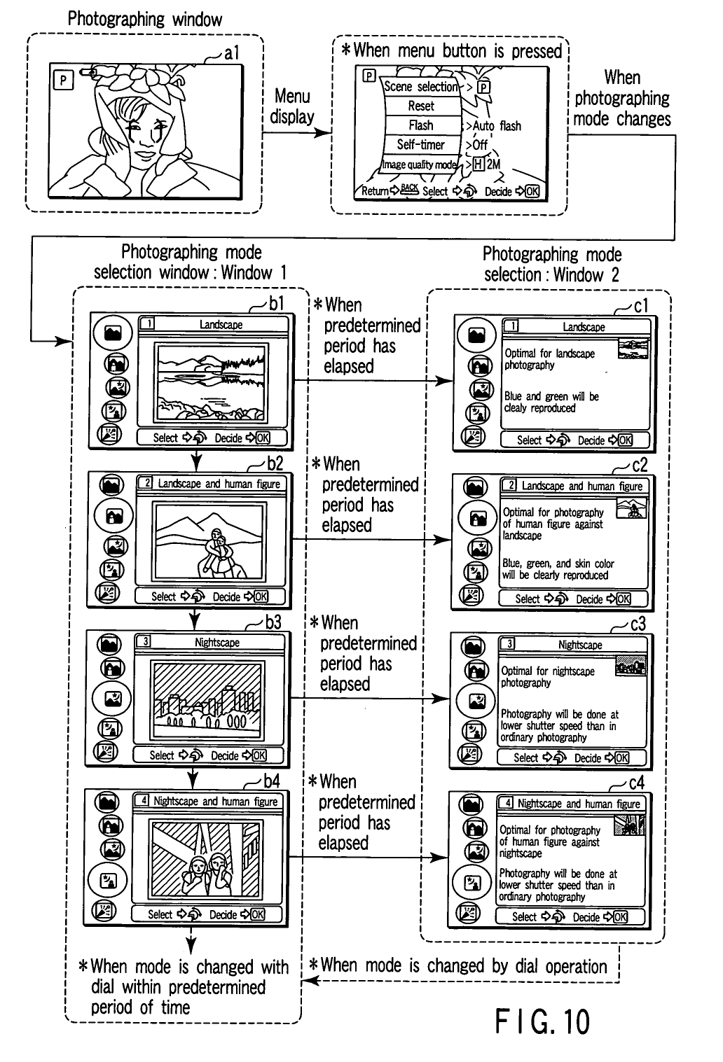

Note that the above description has exemplified the case wherein the photographing window a1 is shifted to the window b1 for scene selection in response to the operation of the dial 9. However, for example, as shown in FIG. 10, it suffices if a menu including “scene selection” as a choice is displayed on the LCD 4 when the menu/OK button 5 is pressed, and the window is shifted to the window b1 for scene selection when the menu/OK button 5 is pressed while the “scene selection” is selected with the dial 9.

FIG. 11 is a flowchart showing a control sequence executed by the system controller 28 to realize this window transition. Upon being notified by the operation unit 29 of the operation of the menu/OK button 5 (YES in step C1), the system controller 28 reads out pieces of information for menu display from the EEPROM 32, and instructs the display control unit 23 to display the menu window formed by these pieces of information on the LCD 4 (step C2). When the system controller 28 is notified by the operation unit 29 of the operation of the dial 9 or menu/OK button 5, and the operation corresponds to the selection of “scene selection” (YES in step C3), the system controller 28 executes scene selection processing (step C4).

As described above, the transition of windows from, for example, the photographing window a1 to the window b1 for scene selection can be variously modified.

As described above, in the camera and the control method for the camera according to the first embodiment, in order to support a user in selecting one of a plurality of scenes prepared in the scene selection, stepwise guide display is executed in consideration of the fact that information is to be presented by using the compact image display device and different users differ in knowledge and degree of skill. That is, in the first step, display operation of displaying a sample image of a given scene as an element is performed, and in the second step, display operation of displaying the description of the scene as an element is performed.

Performing such stepwise guide display makes it possible to present sample images and descriptions in an eye-friendly manner even by using a compact image display device. In addition, this can provide a user who has knowledge or skill to such a degree that he/she requires no description with an efficient operation environment in which he/she can omit the presentation of unnecessary information.

According to the above description, a monitor image including a sample image as an element is switched to a monitor image including a description as an element under the condition that a predetermined period elapses. However, the present invention is not limited to this, and display switching may be executed by predetermined operation even within the predetermined period. In contrast to this, display switching may be performed from a monitor image including a description as an element to a monitor image including a sample image as an element.

### Second Embodiment

A second embodiment of the present invention will be described next.

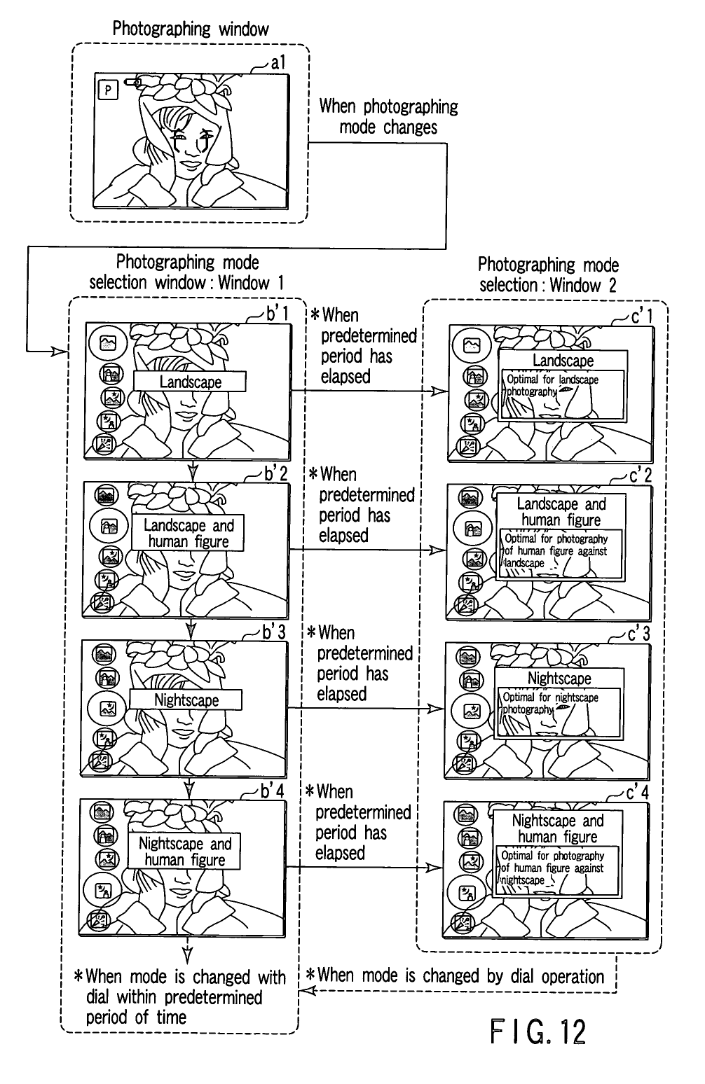

FIG. 12 is a view of window transition which shows the flow of scene descriptions in the scene function executed by this camera. The second embodiment differs from the first embodiment in the following points. First, the display element of a first-step explanatory window b′1 is a title instead of a sample image. Second, both the first-step explanatory window b′1 and a second-step explanatory window c′1 are superimposed on a photographing window al displayed as a monitor image to present information necessary for a scene description.

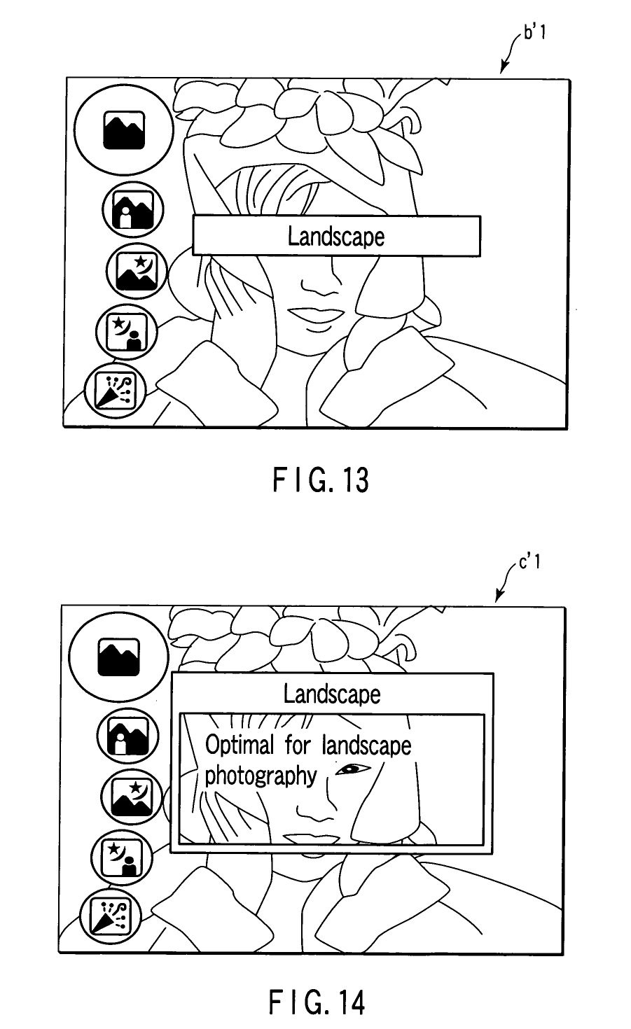

FIG. 13 is an enlarged view showing the first-step explanatory window b′1 to make it easier to understand. FIG. 14 is an enlarged view showing the second-step explanatory window c′1 to make it easier to understand.

As shown in FIG. 13, for a skilled user, a title representing the characteristic feature of each scene seems to be sufficient information to be displayed for scene selection. As shown in FIGS. 13 and 14, presenting the respective pieces of information upon superimposing them on the photographing window al can prevent a user from missing a so-called shutter chance.

As described above, in the camera and the control method for the camera according to the second embodiment, in the first step, only the title of a given scene is displayed, and in the second step, the description of the scene is displayed.

As in the first embodiment, performing such stepwise guide display makes it possible to realize efficient control in consideration of the facts that information is to be presented by using the compact image display device and different users differ in knowledge and degree of skill.

In addition, the first and second embodiments are implemented by control processing executed by the system controller 28 in accordance with programs. That is, the above programs themselves implement the functions of the embodiments described above, and hence constitute the present invention.

These programs may be stored in a recording medium other than the EEPROM 32 described above, or may be stored in a recording medium detachably mounted on the camera. As recording media, optical recording media such as a DVD, magnetic recording media such as an MD, tape media, semiconductor memories such as an IC card, and the like can be used as well as floppy disks and CD-ROMs. A recording medium on which these programs are recorded also constitutes the present invention.

In addition, a storage unit such as a hard disk or RAM provided in a server system connected to a private network or the Internet may be used as a recording medium, and programs may be provided therefrom to the camera through the network. Obviously, the present invention incorporates even programs which implement the functions of the above embodiments in cooperation with other applications and the like.

In the first and second embodiments described above, the camera according to the present invention is applied to a digital camera. However, the present invention is not limited to this application. For example, it is obvious that the present invention can be applied to a cellular phone with a video movie function or a camera and a PDA with a camera.

According to each embodiment of the present invention, there can be provided a camera and a control method for the camera which support the operation of selecting an optimal photographing condition from a plurality of photographing conditions on each photographic occasion by efficient procedures.

Additional advantages and modifications will readily occur to those skilled in the art. Therefore, the invention in its broader aspects is not limited to the specific details, representative devices, and illustrated examples shown and described herein. Accordingly, various modifications may be made without departing from the spirit or scope of the general inventive concept as defined by the appended claims and their equivalents.

1. A camera comprising:
a display unit;
a control unit which displays, on the display unit, a first explanatory image and a second explanatory image for selection of a scene for photographing condition setting; and
a selection unit which selects one of a plurality of scenes prepared in the first explanatory image and the second explanatory image,
wherein the control unit displays, as the first explanatory image, a plurality of icon images diagrammatically illustrating contents of the scenes as operation guides for the selection unit and a first sample image as a main image which represents the contents of the scene corresponding to one of the icon images which is selected by the selection unit, and as the second explanatory image, said plurality of icon images and a descriptive image as a main image which describes the contents of the scene corresponding to one of the icon images which is selected by the selection unit.

2. A camera according to claim 1, wherein the control unit displays a second sample image having a smaller image size than the first sample image upon including the second sample image in the second descriptive image.

3. A camera according to claim 1, further comprising:
a storage unit which stores image data of the first sample image; and
a image processing unit which creates image data of the second explanatory image from image data of the first sample image stored in the storage unit.

4. A camera according to claim 1, wherein the control unit displays the second explanatory image after displaying the first explanatory image.

5. A camera comprising:
a display unit;
a selection unit to select one of a plurality of scenes defined for photographing condition setting; and
a control unit which, when one of the scenes is selected by the selection unit, causes the display unit to display a title attached to the scene upon superimposing the title on a monitor image, and causes the display unit to display a description which describes contents of the scene upon superimposing the description on the monitor image after the title is displayed.

6. A control method for a camera including a display unit, a control unit which causes the display unit to display a monitor image associated with a scene for photographing condition setting, and a selection unit which selects an image displayed on the display unit, comprising steps of:
displaying a first explanatory image comprising a plurality of icon images diagrammatically illustrating contents of the scenes as operation guides for the selection unit and a first sample image as a main image which represents the contents of the scene corresponding to one of the icon images which is selected by the selection unit; and
displaying a second explanatory image comprising said plurality of icon images and a descriptive image as a main image which describes the contents of the scene corresponding to one of the icon images which is selected by the selection unit.

7. A method according to claim 6, wherein when the second explanatory image is displayed, the image is displayed, including a second sample image having a smaller image size than the first sample image.

8. A computer-readable recording medium which stores a program for causing a computer to execute a control method for a camera including a display unit, a control unit which causes the display unit to display a monitor image associated with a scene for photographing condition setting, and a selection unit which selects an image displayed on the display unit, the control method comprising steps of:
displaying a first explanatory image comprising a plurality of icon images diagrammatically illustrating contents of the scenes as operation guides for the selection unit and a first sample image as a main image which represents the contents of the scene corresponding to one of the icon images which is selected by the selection unit; and
displaying a second explanatory image comprising said plurality of icon images and a descriptive image as a main image which describes the contents of the scene corresponding to one of the icon images which is selected by the selection unit.
